(19) United States
(12) Patent Application Publication
(10) Pub. No.: US 2023/0333597 A1
(43) Pub. Date: Oct. 19, 2023

(54) Dual Portable Displays and Portable Hub System

(71) Applicant: BT5 Technologies, LLC, Katy, TX (US)

(72) Inventors: Luis Bustamante, The Woodlands, TX (US); Jose Mora, Bogota (CO)

(21) Appl. No.: 18/136,785

(22) Filed: Apr. 19, 2023

Related U.S. Application Data
(60) Provisional application No. 63/332,667, filed on Apr. 19, 2022.

(51) Int. Cl. G06F 1/16

(52) U.S. Cl. CPC G06F 1/1649; G06F 1/1686; G06F 1/1681

(57) ABSTRACT

There is provided a portable system that includes two (2) display monitors, single or dual-rotation axis video-camara, speakers, microphone, memory, rechargeable battery, and USB ports which incorporates the flexibility to use is at home or office and easily take it on the go. The present invention can interact mechanically, electronically, visually and/or orally with the user or third parties and be used in different applications. Internal and external structures house additional and/or extended electronic boards, wireless connectivity, and connectors which manage, interface and/or detect the signals obtained from a computer or other type host, and receive and/or send signals to another external devices such as a computer, PC tablets, consoles, smartphones, among others.

### CROSS REFERENCE TO RELATED APPLICATIONS

This application claims the benefit of and priority to U.S. Provisional Application Ser. No. 63/332667 which was filed on Apr. 19, 2022 and is incorporated by reference herein in its entirety.

### FIELD OF THE INVENTION

The present invention relates generally to a technological portable monitor hub system. More particularly, the present invention relates to a hub with multi-functional capabilities for a dual auxiliary portable monitors with rotative video-camera, microphone, speakers, data storage, power bank, wireless and wired connectivity, and auxiliary USB ports for data and power charge transmission support.

### BACKGROUND

There are portable monitors that include one (1) display, other peripherals and USB ports in the same chassis. There is a need to have a new portable solution that now includes in the same case two (2) displays, peripherals and USB ports that allow to further improve performance and multi-tasking capabilities when leaving home or the office, that is lightweight, plug-and-play, that only requires one (1) connection cable to the computer or host, and that can be carried in the hand, a backpack or briefcase when the user wants it.

### SUMMARY OF THE INVENTION

The present invention provides the user with a new type of dual portable display with a hub system that includes connectivity and capabilities for enhanced performance and entertainment in any place and especially when traveling. With the present invention, this new dual portable display and peripheral hub system has extended functionality within the apparatus as a unitary system or with attachments. This invention exchanges data wired or wirelessly with the computer and different apparatuses and accessories such as a touch-screen, sensors, among others, and it can be used in different applications such as personal use, entertainment, office, home and for marketing applications.

The dual portable display and peripheral hub system of this invention includes in one frame different features such as a primary monitor with display or screen of between 13″ to 22″ having 15.6″ as a preferred size, a secondary monitor with display or screen of between 7″ to 17″ having 10.1″ as a preferred size, a single or dual-axis rotative video-camera, microphone, speakers, internal memory, power bank, wireless and wired connectivity, auxiliary USB ports, among others.

The internal structure of this invention is designed to house electronic boards and connectors of the latest technology that manage, interface and/or detect the signals obtained from computers, cellphones or other devices connected, and receive and/or send signals to internal components such as two (2) displays, microphone, speakers, video camera, USB data/power ports, among others.

Some of the uses of this invention would be the following: a portable secondary and tertiary monitors system: to extend or duplicate the computer screen in other two displays to enhance performance and multitasking when traveling or working at home or office; a rotative video-camera: to take videos or photos easily and in any direction without moving the computer; independent audio peripherals: to alternatively use a secondary microphone or speaker in case any of the computer ones fails; and a USB hub: to connect other apparatuses in the USB Ports to transmit data and/or power;

The present invention is a dual portable display and peripheral hub system with enhanced functionality, including a set of electronics for internet and electronic communication with a computer and other apparatuses. The usage of this invention is explained later herein. The present invention comprises a primary display monitor with the unitary device housing a set of electronics for wireless and wired communications with a computer and other apparatuses. A secondary medium size display monitor joined to the top edge of the primary monitor, and a support base joined to the bottom edge of the primary monitor, both are joined to the primary monitor by means some friction hinges that allows 360° of rotation. The dual portable monitor has input buttons to configure the settings of the portable monitors and peripherals included in this invention, and alternatively can be programmed by software housed in a connected host. The invention includes a USB hub that permit the connections of other apparatuses via a USB-A, USB-C, HDMI, Micro HDMI, and/or Audio Jack ports, among others, that send or receive the signal of power, data and video from/to the computer or other apparatuses. These ports that can be located on the lateral face of the primary monitor or can be included in the support base of this invention.

In an embodiment, there is provided a portable hub system which comprises a primary display device and a secondary display device which is pivotally and rotatably connected at an edge of the primary display device. A support base is pivotally and rotatably connected to a second edge of the primary display device and the support base has a pair of arms and a bottom area which form a U-shape to define an opening which receives the secondary display device in a closed position. The support base acts as a stand when folded into an open position. A built-in rotatable camera is attached to the primary display device which unfolds upwards by means of a frictional hinge. The portable hub system includes the secondary display device as smaller in size relative to the primary display device.

In an embodiment, there is a portable monitor system which includes a first display device and a second display device pivotally and rotatably connected at a first edge of the first display device; the first and the second display devices are of the same size and deploy vertically. A support base pivotally and rotatably connected to a second edge of the first display device is included where the support base has a pair of arms, preferably parallel to each other, which are connected by a cross piece, preferably perpendicular to the arms but other shapes and angles are include within the scope. The pair of arms are attached to the first display device. The pair of arms and the cross piece define an opening and the support base is received on a back side of the first display device when folded into a closed position and the support base acts as a stand for the portable monitor system when placed in an open position. A built-in rotatable camera is attached to the first display device which unfolds upwards by means of a frictional hinge. Although a pair of arms is noted by the drawings, any number of arms may be used to provide the support for the weight of the monitor systems. The portable monitor system in an embodiment requires only a single wired connection to transfer power and data to and from a host computer. The portable monitor system includes an embodiment where the second display device is rotated 90 degrees relative to the first display device. The portable monitor system includes an embodiment where the built in rotatable camera has two rotation axes and is raised to a height of more than 15″ above the support base.

For each of the embodiments included herein, the portable hub system includes features that the unitary hub device operates with or without an internal power source and has the housing of two monitors. There is housed a set of electronics for wireless and wired communications with a computer and other apparatuses and the devices have input buttons to activate internal components and software to transfer power and data with a computer or other apparatuses simultaneously. The present invention is a foldable structure to house all the components and there is at least two portable monitors to be connected in the present invention and which can act as a secondary and tertiary extended screens of a computer of other apparatuses. The present invention has a built-in single-rotation axis video-camera, or alternatively a built-in dual-rotation axis video-camera. A built-in speaker, microphone, and memory are included in the display devices. The present invention also has a compact design for easy transport and portability. The present invention includes software and hardware to be used as a simple plug-and-play system in connection with the system, along with printed circuit boards to include an operational system to act as a computer. These and other features of the present invention and embodiments will be further described herein.

### BRIEF DESCRIPTION OF DRAWINGS

FIG. 1A and 1B show the top and bottom isometric views of this invention in the unfolded position.

FIG. 2A shows a bottom left isometric view of this invention.

FIG. 2B shows the detail of the side USB hub connecting ports of this invention.

FIG. 3A shows a bottom right isometric view of this invention,

FIG. 3B is a detail of the operation buttons of this invention.

FIG. 4A and 4B show the top and bottom isometric views, respectively, of this invention in closed position and ready for storage and/or transportation.

FIG. 5A and 5B show the isometric views of steps 1 and 2, respectively, to unfold this invention.

FIG. 6A shows the configuration for the use of this invention with 2 displays facing the front.

FIG. 6B shows the configuration with one monitor facing the front and the other facing the rear.

FIG. 7 shows in top isometric views the rotative feature of the secondary display included in this invention.

FIG. 8A shows a top isometric view of this invention, pointing to the camera included.

FIG. 8B shows the detail of the rotation of the camera included in this invention.

FIG. 9A shows a top isometric view of this invention, pointing the camera rotated towards the back.

FIG. 9B shows the detail of the rotation of this camera included in this invention.

FIG. 10A shows the isometric view of an alternative dual-rotation axis camera attached to the principal monitor and in the closed position

FIG. 10B shows the detail illustration of the camera.

FIG. 11A and 11B show detailed views of the vertical and horizontal rotation axes of the dual-rotation axis camera included in this invention.

FIG. 12A shows an isometric view of this invention connected to a computer and using its 2 display monitors towards the user.

FIG. 12B shows a rear isometric view of this invention, with the primary display monitor seen in the same direction as the computer screen, and the secondary display monitor folded towards the back to view from behind.

FIG. 13 illustrates the electrical connections of the present invention.

FIG. 14A illustrates a version of this invention with two monitors of the same size in closed position.

FIG. 14B illustrates the lower part of the invention described in FIG. 14A.

FIG. 15A illustrates the invention in frontal deployed position.

FIG. 15B illustrates a right-side view of the invention in deployed position.

FIG. 16A illustrates a right isometric view of this invention in the deployed position.

FIG. 16B illustrates the rear view of FIG. 16A.

FIG. 17A illustrates as version of the invention with the monitors deployed in opposite positions.

FIG. 17B illustrates the rear view of FIG. 17A.

FIG. 18A illustrates a version of the invention in use, rotated 90 degrees to the right.

FIG. 18B illustrate the rear view of FIG. 18A.

FIG. 19A illustrates a version of the invention in frontal use with a computer.

FIG. 19B illustrates a version of the invention in front and rear use with a computer.

FIG. 19C illustrates a use version of the invention rotated 90 degrees and with a computer.

### DETAILED DESCRIPTION OF THE DRAWINGS

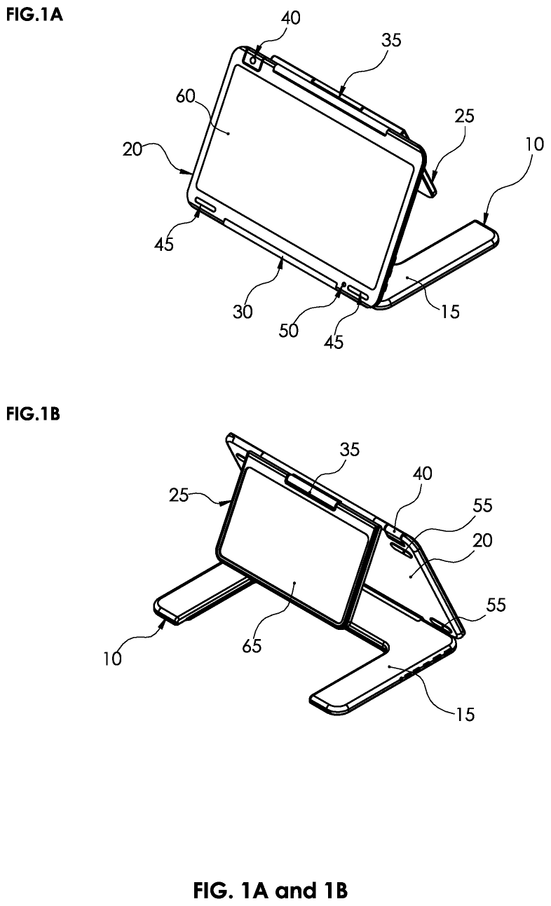

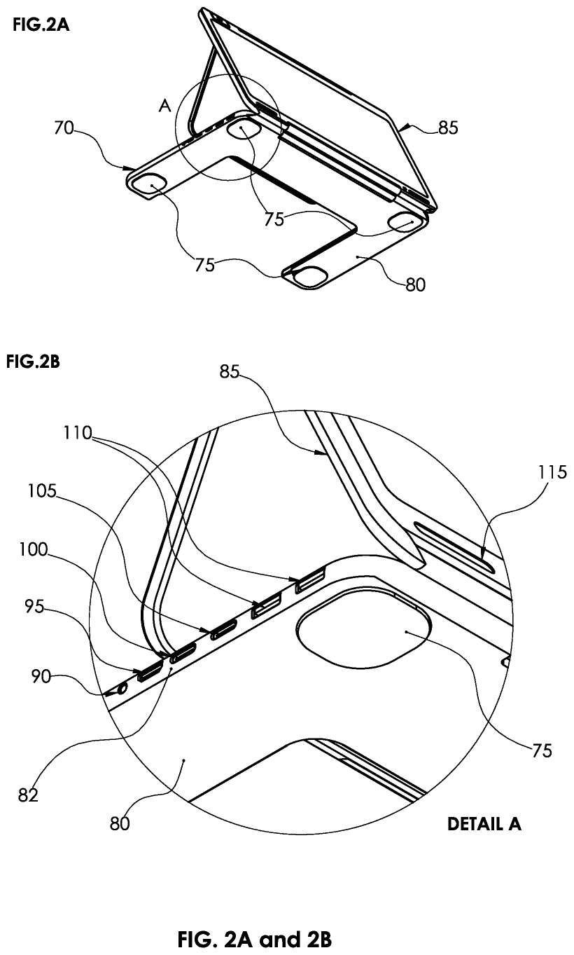

The FIG. 1A shows a top isometric view of this invention 10, which is made up of a primary display monitor 20 of between 13″ to 22″ having 15.6″ as a preferred display size, with the possibility of having a touch function 60, the chassis of the primary monitor 20 contains the electronic components that allow the operation of the primary monitor, and alternatively the boards to provide data and power to the camera 40, microphone 50 and speakers 45. As used herein, the words display and monitor can mean the same, except if otherwise specified. The boards to control some or all the peripherals included in this invention would be also located in the support base 25 or in the secondary monitor 25. Attached to the upper part of the primary monitor 20 by means of the hinge upper 35, there is the secondary monitor 25 which includes a panel that can be of between 7″ to 17″ having 10.1″ as a preferred size 7″ and that can include a touch function 65. Likewise, on the lower edge of the chassis of the primary monitor 20 and joined by the lower hinge 30 is the support base 15, which supports this invention in different unfolded positions. Inside the support base 15 are included some of the electronic components that allow the operation of this invention, such as the different connection ports with their respective PCB boards and the option of including a rechargeable battery or other additional options for this invention. FIG. 1B shows a rear isometric view of this invention 10 where the possibility of rotating the secondary monitor 25 at an angle of 360° is shown, which allows the display 65 of this monitor to be seen from behind of the primary monitor 20, this function is especially useful for sharing images and information or make presentations more confidentially to a user on the opposite side. Also seen are the non-slip pads 55 included on the back of the primary monitor 20 that protect it and give it greater stability when this device is placed closed on a surface.

In FIG. 2A includes a bottom isometric view of this invention 70, the non-slip pads 75 placed in the lower part of the support base 80 are observed, which improve the adherence of this invention 70 on a surface when it is unfolded and in use. FIG. 2B shows detail A where the connection ports of this invention 70 are observed, located on the left side 82 of the support base 80, in another configuration it is possible to integrate these ports in the chassis of the primary monitor 85, unifying all the electrical components in this area for easy connection to a host. Among the ports included in this invention 70 are an audio jack 90 output port for connecting auxiliary peripherals such as hands-free headsets, microphones and/or speakers, a micro HDMI or HDMI input port 95 to transmit data from another device and be displayed on one or both monitors included in this invention, a USB-C port 100 to receive data and power to this invention, either from another host device or with an A/C power adapter, a USB-C data and power port 105 which allows this invention to be connected to another device using a single cable to transmit data and power at the same time, two or more USB-A 2.0 or 3.0 ports 110, which allows the connection of other devices to this invention 70, to transmit data or power charging to said devices. This view also shows the position of the speaker 115 on the front just below the panel of the primary monitor 85.

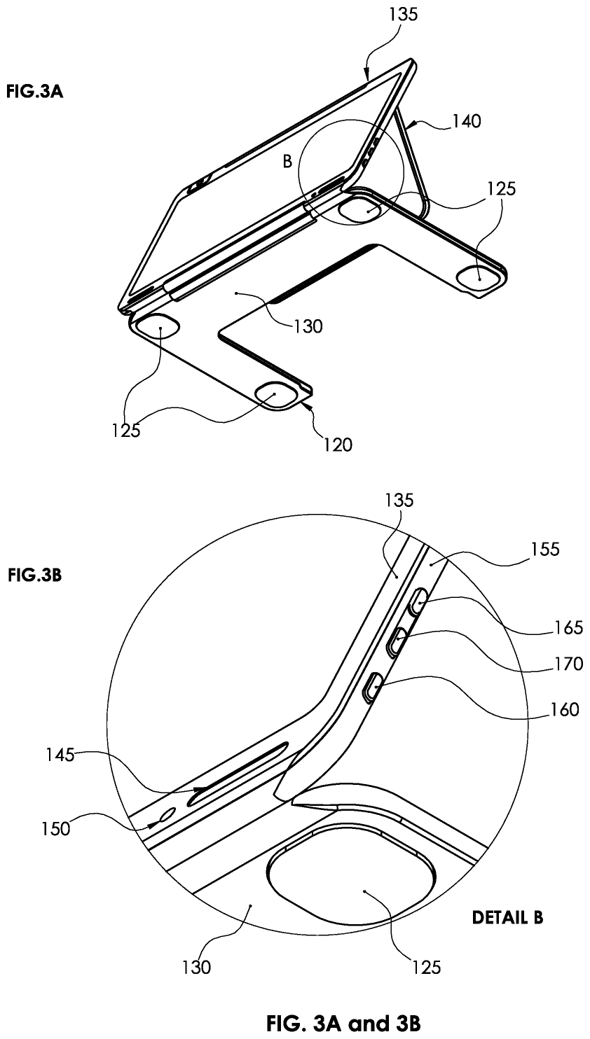

FIG. 3A includes a bottom isometric view of this invention 120, showing the primary monitor 135 and the secondary monitor 140 unfolded to the back, and where the non-slip pads 125 placed on the support base 130 are observed. FIG. 3B refers detail B that shows the speaker 145, the microphone 150, and the configuration buttons located on the right side of the chassis 155 of the primary monitor 135 on the front of this invention 120. The on/off-Menu button 160, can be seen in the detail. By pressing this button for about 2 seconds will turn on and off the primary monitor, and by pressing slightly the Menu functions will be available on the display of the primary monitor 135 to configure as the level of brightness, contrast, sharpness, among other features. This detail also shows the (+) button 165 and the (−) button 170 with which the values of each item in the configuration menu are controlled, including the control of volume of this invention. If required, this invention can include a greater or lesser number of buttons as needed. The secondary monitor 140 would include just one button for on/off. Another alternative to set up the features of both displays included the primary 135 and secondary 140 monitors, is by means of an application software that would be embedded in this invention and downloaded automatically in the computer or another host once it is connected, or that is available in the internet for downloading.

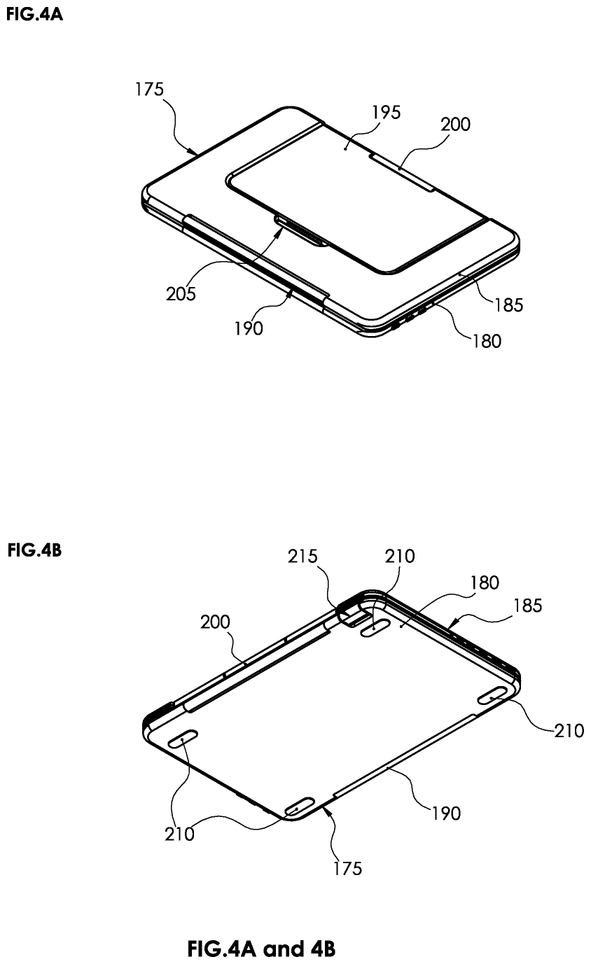

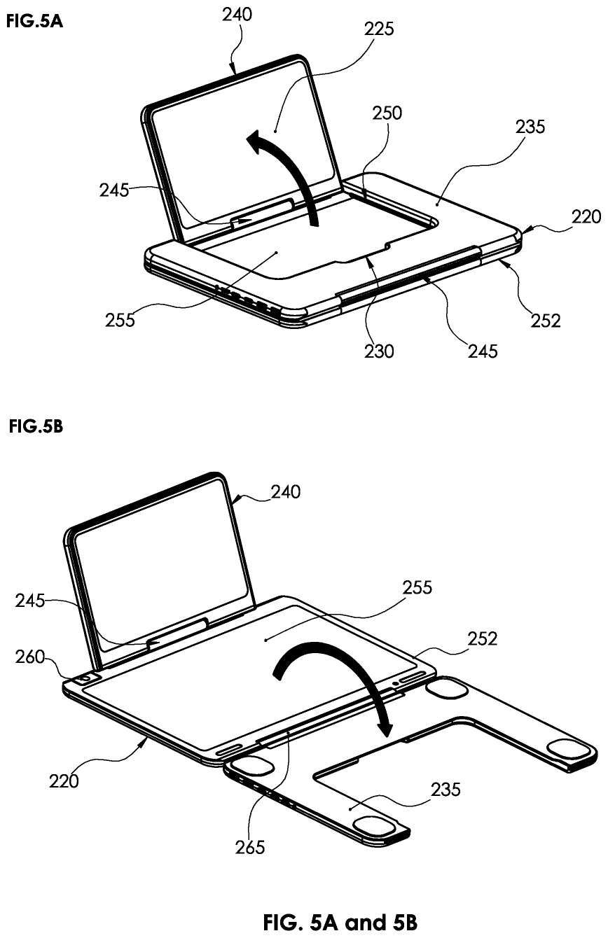

In FIG. 4A an isometric view of this invention 175 fully closed is shown. In this position, the chassis of the primary monitor 180 works as a base, and the panel is covered by the support base 185 that folds over the chassis of the primary monitor 180 by means of the lower hinge 190, and subsequently the secondary monitor 195 folds on the support base 185 using the upper hinge 200 and resting on the stop tab (see 250 of FIG. 5A), in this way, the monitor panels are facing each other but without contact between them, being protected from any blow or damage during transport. The support base 185 includes an opening slot 205 that facilitates the deployment of the secondary monitor 195 by inserting the fingers and pulling upwards. FIG. 4B is the bottom isometric view of this invention 185 showing the chassis of the primary monitor 180 and the non-slip pads 210 that help this invention maintain its position on a surface. This figure shows the rotating camera 215 stored in the chassis of the primary monitor 180.

FIG. 5A is an isometric view of this invention 220 showing step 1 of deploying this device for use. The secondary monitor 240 is unfolded by inserting the fingers into the opening slot 230 of the support base 235 and holding the upper edge of secondary monitor 240 to find upwards, in this way, the upper hinge 245, which is a friction hinge or similar accessory that maintains its position, will direct the opening of the secondary display 225 to place it at the angle that the user prefers. In this way it is possible to use only the secondary monitor 240, without the need to unfold the entire invention 220. The secondary monitor 240 rests on the stop tab 250 of the support base 235 when it is folded and prevents any contact between the primary display panel 255 and the secondary display panel 225 (of FIG. 5B) of the primary 252 and secondary 240 monitors included in this invention 220. FIG. 5B shows the second step of the deployment sequence of this invention 220, with the support base 235 start to be unfolded, which rotates by means of the lower hinge 265 which, like the upper hinge 245, are friction hinges that maintain the position of the sections as required, in this step the primary display panel 255 is uncovered.

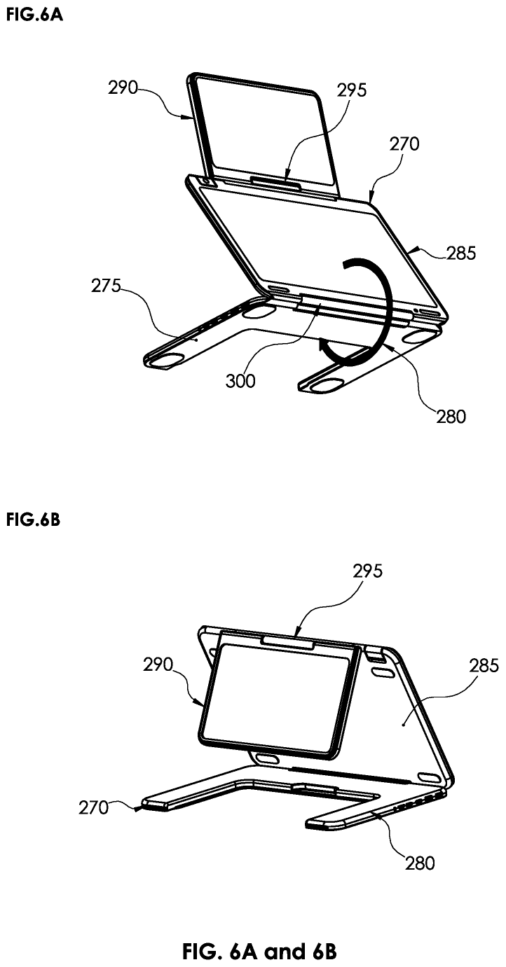

FIG. 6A shows the third step of the deployment of this invention 270. The support base 275 is rotated at a total of approximately 295° 280 which allows that, when supporting this invention on the support base 275, the viewing angle of the primary monitor 285 is about 65° versus the horizontal, remaining in a more comfortable position for viewing by the user. The tilt angle of both the primary monitor 270 and the secondary monitor 290 may be adjusted by the user to facilitate the desired viewing. Depending on the inclination of the surface where the support base 275 is placed, it will then depend on adjusting the positions of each monitor so that this invention remains stable, which the user can do intuitively. The friction hinges 295 and 300 will maintain the set angles under minor movements of the invention, as do most commercially available laptops on the market. FIG. 6B shows a deployment configuration of this invention 270, where the secondary monitor 290 is rotated about 245° with respect to the horizontal, allowing the secondary monitor 290 to be viewed from the rear of the primary monitor 285. This invention 270 includes a rotation sensor (G sensor or similar) that which allows auto-rotate the image of the secondary monitor 290 when exceeding a certain angle of rotation. This deployment configuration is especially useful for making presentations or sharing information in a more controlled way to other viewers.

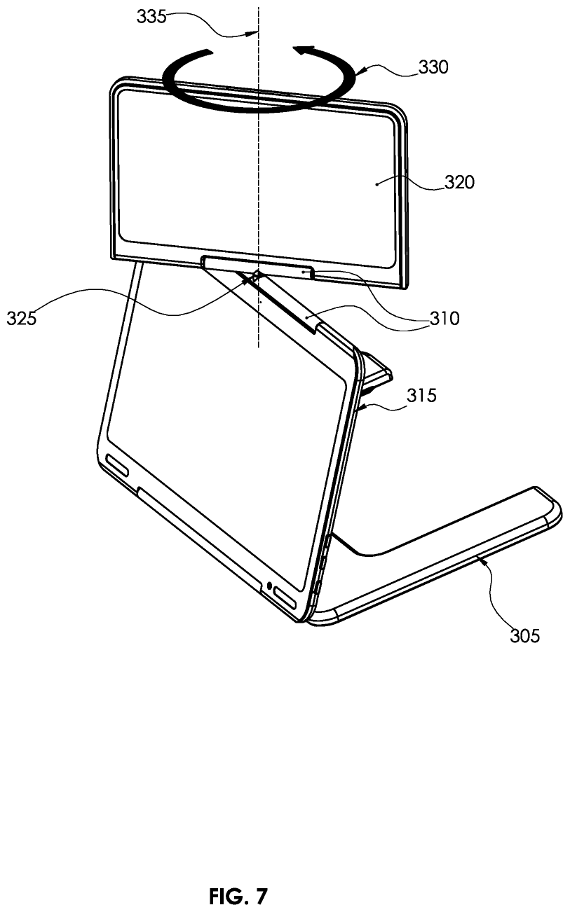

FIG. 7 shows a dual-axis rotating secondary monitor 320 version of this invention 305, where the upper hinge 310 that joins the primary monitor 315 with the secondary monitor 320 and that allows their vertical deployment, includes a rotation hinge horizontal 325 that allows the secondary monitor 320 to rotate about 360° 330 about a horizontal axis 335 on the primary monitor 315, increasing the viewing angle possibilities of both monitors.

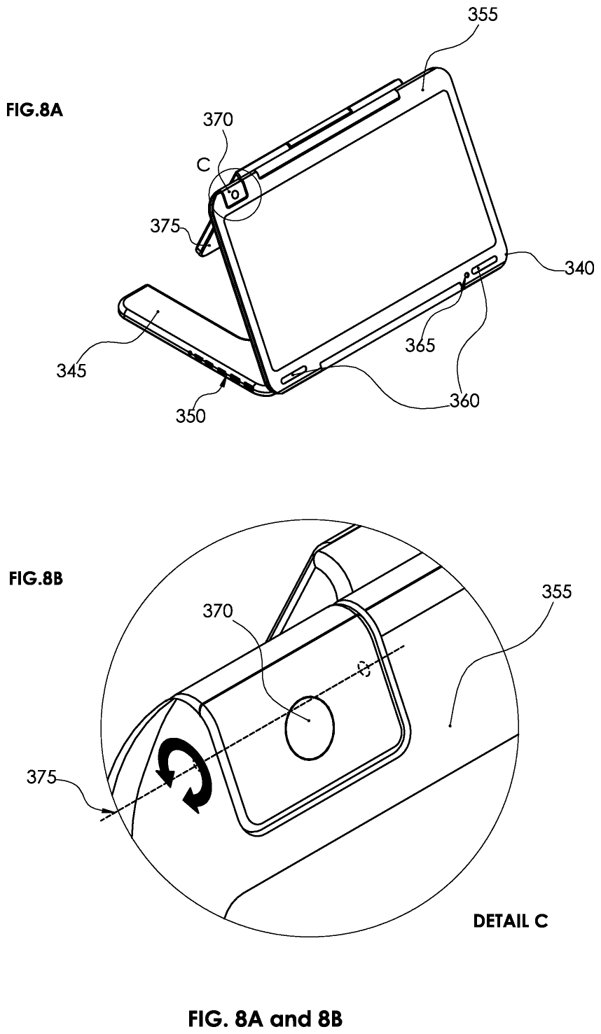

FIG. 8A shows an isometric view of this invention 340 unfolded and supported by the support base 345 where the connection ports 350 are located. Attached to the support base is the primary monitor 355 that contains peripherals such as speakers 360, microphone 365, and a rotating single-angle camera 370, and in turn attached to the primary monitor 355, is the secondary monitor 375 deployed with a view to the rear. FIG. 8B shows detail C that corresponds to the rotating function of the camera 370. The rotating camera 370 rotates on a single axis 375 in a range of about 180° which allows to adjust the viewing angle, either directed towards the user in front of the primary monitor 355 or view the opposite area or the primary monitor 355, very useful to use it in video conference calls as an alternative camera of the laptops, among other potential usages.

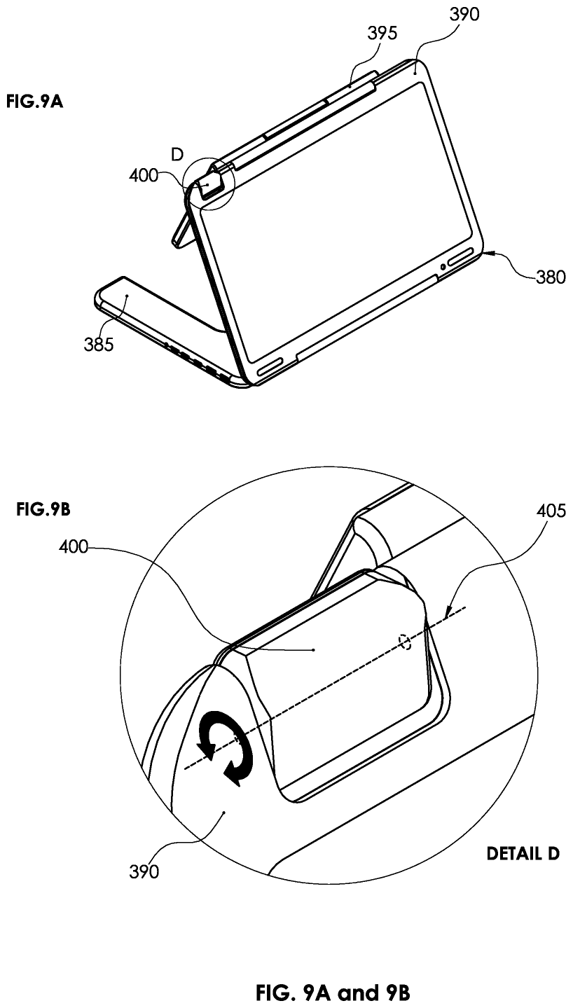

FIG. 9A shows an isometric view of this invention 380 unfolded, supported by the support base 385, with the primary monitor 390 unfolded and the secondary monitor 395 rotated back. FIG. 9B shows detail D, which corresponds to the single-axis rotating camera 400. This view shows how camera 400 can rotate around axis 405, pointing the camera towards the opposite side of the principal monitor 390 of this invention.

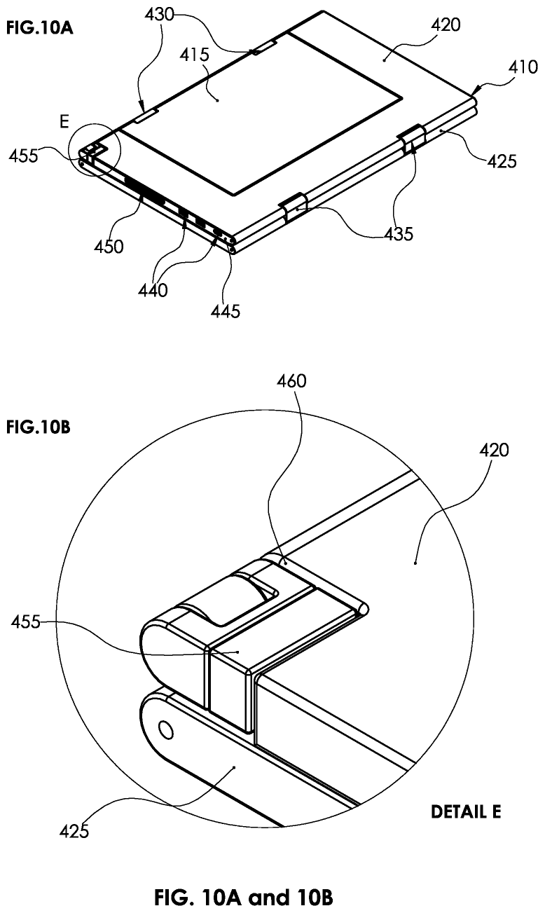

FIG. 10A shows an isometric view of this invention 410 in which the secondary monitor 415 and the support base 420 are joined to the primary monitor 425 by means of the hinges 430 and the hinges 435. The support base 420 includes the connection ports 440 on the left side 445, the speakers 450 on each side, and the dual-rotation axis camera 455 in the upper left corner. FIG. 10B is detail E of the dual-rotation axis camera 455 which is located in the upper left part of the primary monitor 425 and is stored in the cavity 460 located in the left -or right- corner of the support base 420 when this invention 410 is folded.

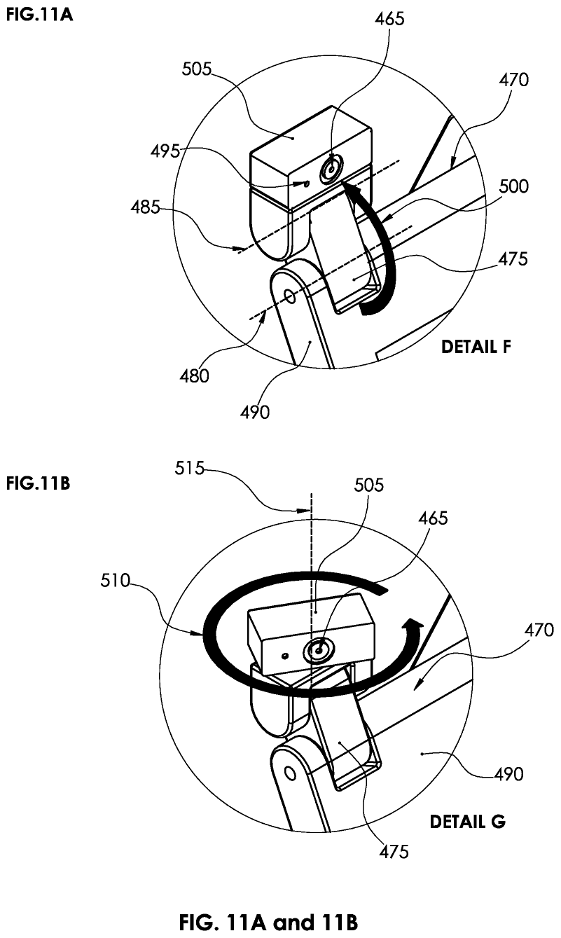

FIG. 11A shows detail F of how the dual-rotation axis camera 465 included in this invention 470, unfolds upwards by means of a friction hinge 475 with double axis 480 and 485 that allows it to rotate about 180° on each axis, giving it a range total about 360° 500 swivels. This friction hinge 475 attaches the dual-rotation axis camera 465 to the chassis of the primary monitor 490 and allows to put and fix the camera 465 at any angle the user requires. The camera 465 includes an LED and/or sensor type of indicator 495 that activate recording or other action, and/or shows when the camera is in use. FIG. 11B shows the detail G of the dual-rotation axis camera 505 where it is observed how the lens module 465 can rotate 360° 510 on a Y axis 515 that allows to adjust the lateral angle of view of the lens module 465 as required by the user.

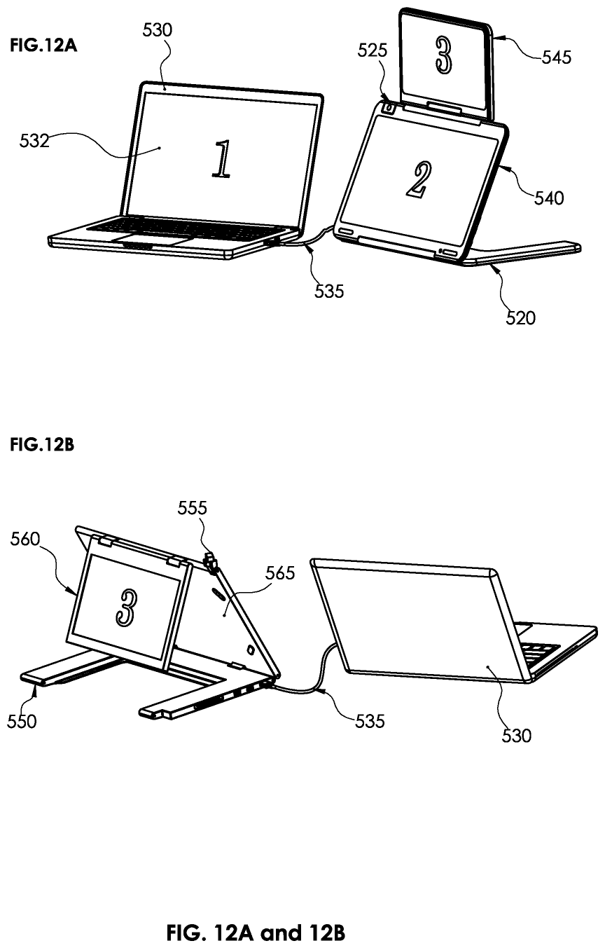

FIG. 12A shows this invention 520 with a single-rotation axis camera 525 connected to a laptop 530 through a USB-C type 535 or similar type of cable and thus be able to transmit power and video to the USB hub, and through an interface controller, power a rechargeable battery and/or the primary monitor 540, and/or the secondary monitor 545 at the same time and independently. In this configuration, the primary monitor 540 and the secondary monitor 545 are in the direction of the user's view having access to 3 displays at the same time, including the laptop screen 532. FIG. 12B shows a version of this invention 550 with the dual-rotation axis camera 555, connected to a laptop 530 using a USB-C type cable 535. In this case the user has access to the laptop screen 532 and the primary monitor 565, and the secondary monitor 560 is rotated -or not- to the opposite side to make a presentation to others while keeping the information on displays 1 and 2 confidentially.

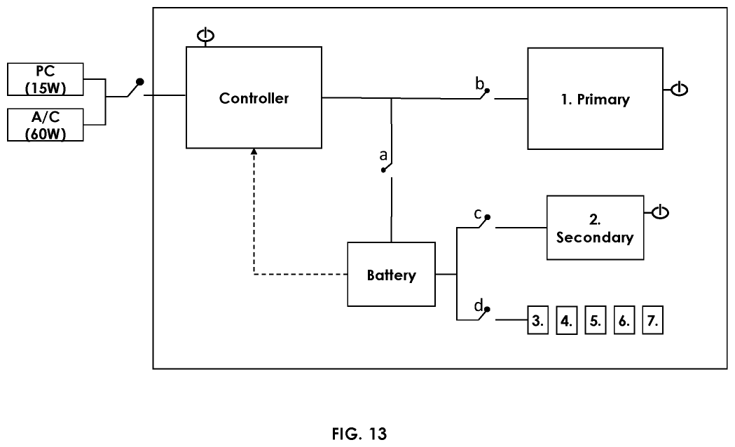

FIG. 13 shows an option of power delivery and control of this invention. This invention is designed so that when receiving power and data from the host, they enter a controller and this provides energy to a rechargeable battery which provides power to the secondary monitor and peripherals; while the controller provides parallel power to the principal monitor. The controller measures the voltage and/or energy available in the rechargeable battery of this invention, and in case the battery decreases its capacity below a predetermined limit, then the controller would deactivate some or all the peripherals, later the secondary monitor, as programmed by the firmware. All programming could be preset via firmware from factory, or via buttons or by an application software adjustable by the user. This invention can house additional PCB boards in the primary and/or secondary monitors for the invention to operate as a laptop with 2 displays and connect a wired or wireless keyboard for data entry.

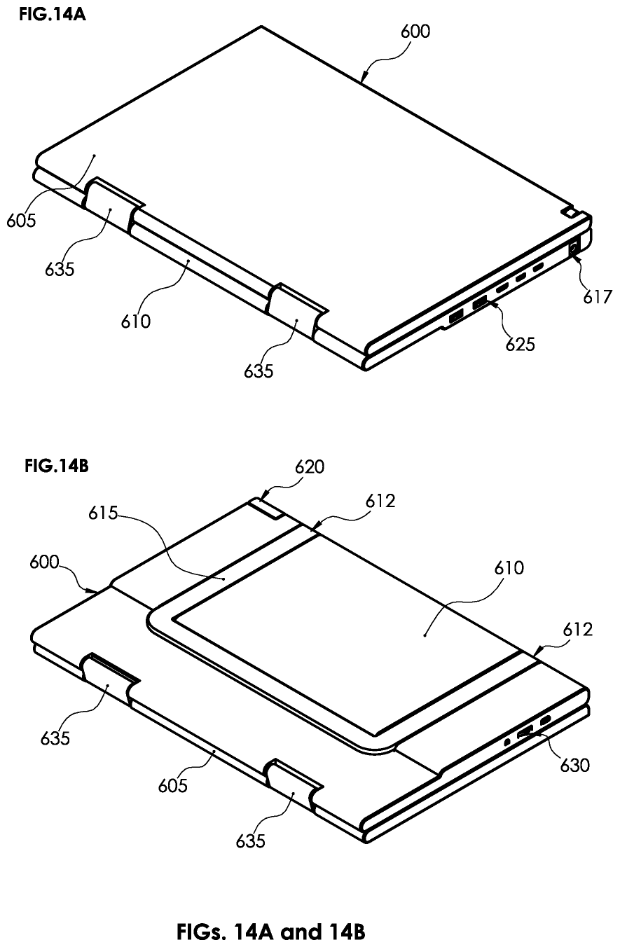

FIG. 14A shows a version of this invention 600 with two displays of the same size in the closed position and in top view. This version has the power and data ports section 625, and the power port 617. This invention can include a rechargeable battery and/or a wireless module for connection to the host or computer without a cable. It includes the lower display 610, the upper display 605, and the two hinges 635 that join such displays.

FIG. 14B shows the bottom view of FIG. 14A in which this invention 600 is observed with its two hinges 635 that connect the lower display 610 with the upper display 605. The displays controls 630 are shown in the side area and they allow changing the configuration of each display, volume, and other features of this invention. Stand 615 is shown folded and connected to the lower display 610 via two hinges 612. The dual-axis rotary video-camera 620, previously described in greater detail in FIG. 11A and FIG. 11B, is folded and inserted into the lower monitor housing 610.

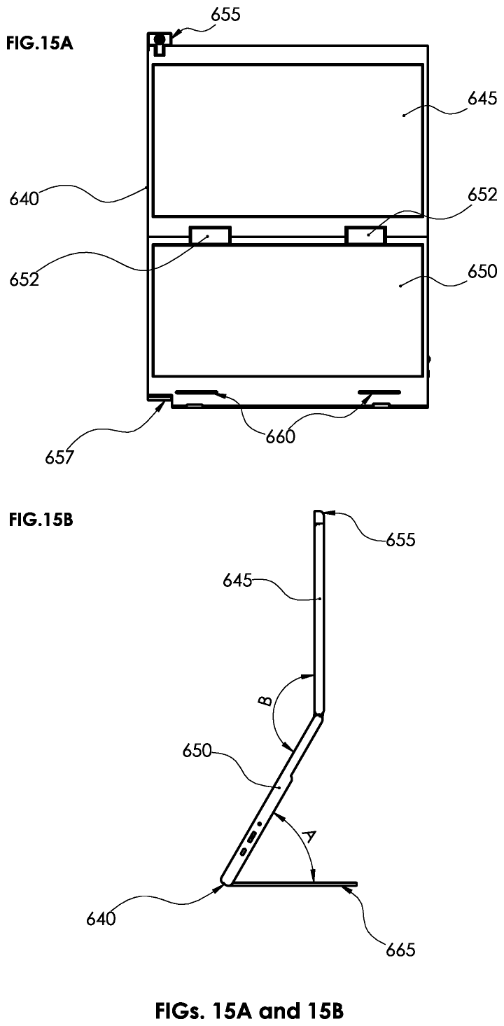

FIG. 15A shows this invention 640 in the unfolded position and in front view, in which the lower display 650 and the upper display 645 can be seen arranged one above the other by means of the hinges 652. The speakers 660 are in the lower display chassis, although they can be located elsewhere in this invention 640. The dual-axis rotary camera 655 is deployed, and at the time of closing the invention 640, the camera chassis 655 enters the cavity 657 of the lower monitor chassis 650.

FIG. 15B shows the right-side view in the deployed position of this invention 640. Stand 665 supports the lower display 650 at different angles A ranging from 1-degree to 180 degrees, with a 60-degree angle being preferred. The hinges 652 of FIG. 15A can support different angles B between 1-degree and 180 degrees, between the lower display 650 and the upper display 645, with a preferred angle of 150-degrees for when both displays are facing the same side. The balance point of this version of invention 640 depends on the angles A and B. This invention can also include an additional similar stand attached to the upper display, in the opposite position and mirror to the stand 665, to achieve a U-shaped support and greater stability in different positions, such as placing the two monitors facing the sky supported by the two U-stands, and with a mechanical wedge that keeps the two monitors aligned with each other.

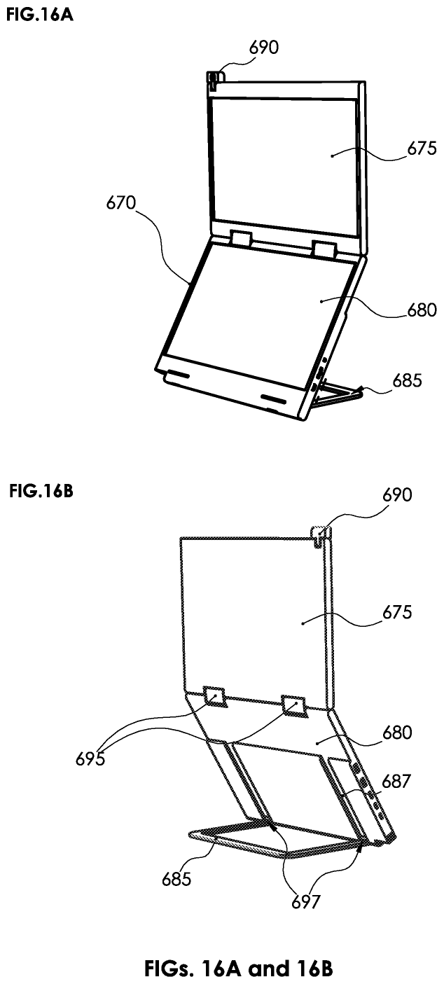

FIG. 16A shows an unfolded right isometric view of this invention 670, with lower display 680, upper display 675, dual axis rotary video-camera 690, and the hinges 697 of stand 685.

FIG. 16B shows the rear view of FIG. 16A showing the lower display 680, the upper display 675, the dual axis rotary video-camera 690, the two hinges 695 connecting the two displays, and the two hinges 697 that sustain this invention in a stable manner. Stand 685 enters slot 687 of display 680 upon closing of this invention.

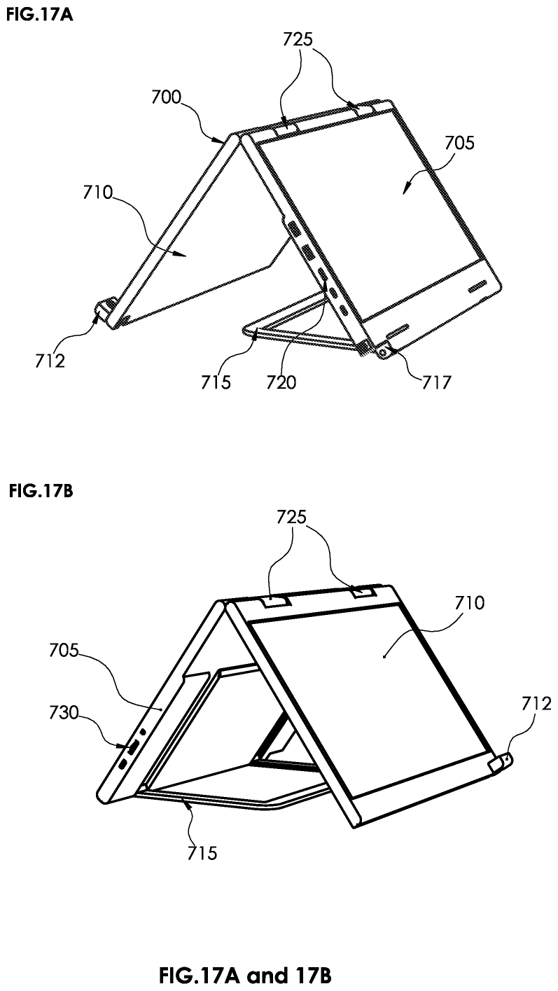

FIG. 17A shows this version of the invention 700 in the deployed position with the upper display 710 and the lower display 705 in opposite positions, supported by hinges 725. Stand 715 provides stability to the invention in the horizontal position. The data and/or charging ports 720 are located on the left side of the lower display 705. The dual axis rotary video-camera 712 in undeployed position to permit the upper display 710 to deploy at any angle of the back side of the lower display 705. The dual axis rotating camera is housed in cavity 717 of the lower display 705 when this invention is folded.

FIG. 17B shows the rear position of FIG. 17A in which the lower display 705 is now seen with the control buttons of both displays 730 on the right side of the lower display 710, the stand 715 deployed, the upper display 710 unfolded to the rear, the hinges 725, and the video-camera 712 in undeployed position.

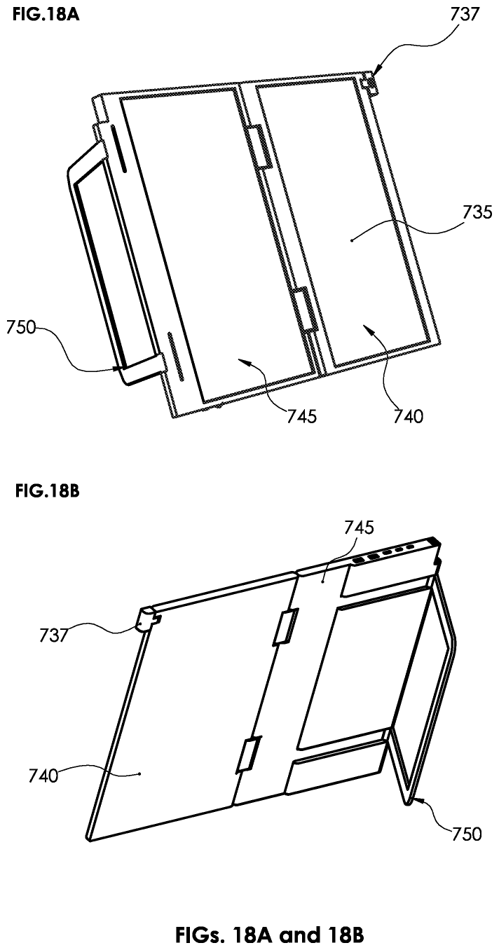

FIG. 18A shows this invention 735 in a position rotated 90 degrees to the right, in which the stand 750 supports this invention 735 with its lower display 745 and upper display 740, each in a vertical position, but positioned horizontally next to each other allowing to use this invention 735 in different applications of use. The electronics included in this invention allow the host to recognize the auto-rotation feature of the invention and reconfigure the distribution of the images on the displays.

FIG. 18B shows the rear view of FIG. 18A in which the upper display 740 and the lower display 745 can be seen connected linearly, with the video-camera 737 and all supported by stand 750.

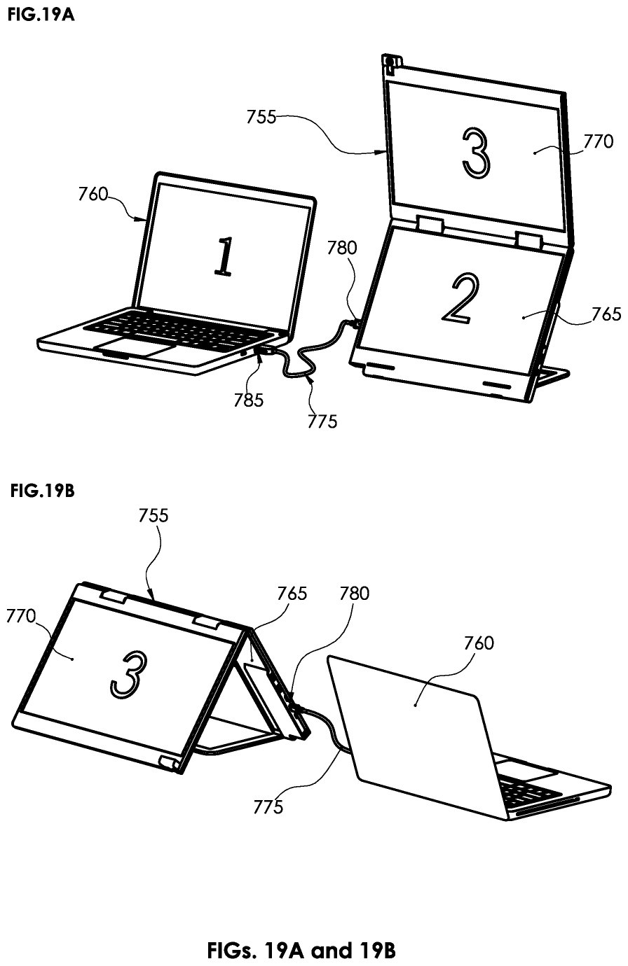

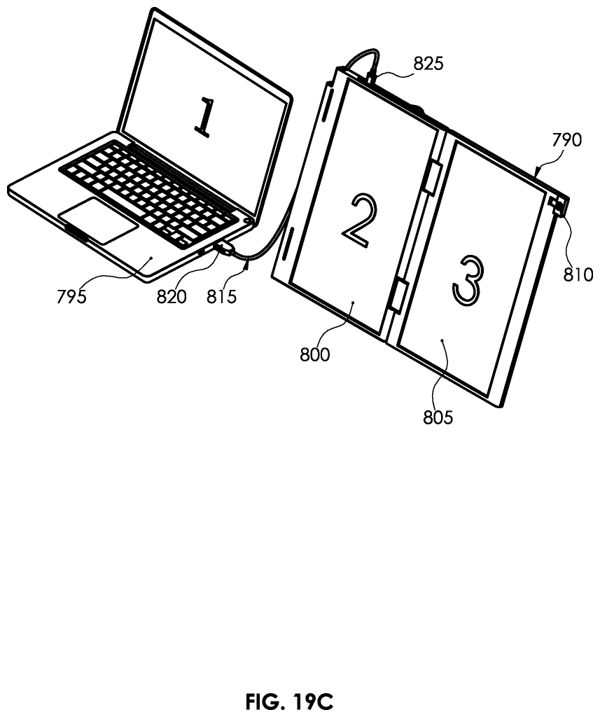

FIG. 19A shows the connection of this invention 755 with a host or computer 760, using a single cable 775 connected to port 785 of the host or computer and to port 780 of this invention 755, to transmit power and/or data between both units. That is, in a version of this invention, this invention could also work as a power bank and provide power charging to the computer or host and other peripherals. In this arrangement, the computer display 1 can act as the main display, the lower display 765 of the invention as number 2, and the upper display 770 as number 3. This invention can include a rechargeable battery and wireless connectivity in such a way that one of its versions can work linked to the host or computer without the need for an interconnection cable.

FIG. 19B shows the rear view of FIG. 19A but with the upper display 770 of this invention 755 rotated rearward. In this configuration, the host or computer 760 is connected to the power and/or data input port 780 of this invention through cable 775 located on the left side of the lower display 765. The displays and electronics included in this invention are low power consumption, in such a way that the total power consumption can be transmitted from a computer by a single USB-C cable or similar that carries power and data, and a separate AC/DC adapter is not required to provide power to this invention.

FIG. 19C shows this invention 790 rotated 90 degrees to the right, connected from its port 825 by a single cable 815 to port 820 of the host or computer 795 to transmit power and data wired to displays 800 and 805 of this invention 790.

### Usage Options of the Dual Portable Display and Peripherals Hub System

The present invention is the first generation of a two (2) portable displays and peripheral hub system that incorporates the flexibility to transport and use different types of apparatuses combining with IoT capabilities, such as a secondary and tertiary monitor, dual-rotative axis video-camera, microphone, speakers, among others, all-in-one portable lightweight and one-cable system.

The internal and external structures are designed to house electronic boards and connectors of the latest technology that can manage, interface, detect, receive and/or send the signals to a computer and/or other apparatuses.

Some of uses of this invention are the following:
1. Use two (2) portable displays on the go: connected to a computer or other host, the dual displays will act as a second and third monitor of the host and the user can duplicate and/or extend other screens for enhanced performance and multitasking;
2. To take photos and videos with a single-rotation or dual-rotation axis camera: when this invention is connected to the computer, in a wired or wireless connection. Users can easily take photos of documents or places looking those at the computer screen or any of the 2 additional displays and then take the photos or video with the computer application, and all photos will be downloaded directly to the computer or this invention. Take photos with the laptops' camera is not easy or maybe impossible in many cases, or it takes longer time to do it with a smartphone because it requires to send the file to the computer via e-mail consuming unnecessary time and data plans.
3. Use microphone, speaker and memory built-in features: in case that the computer ones do not work properly, or the specific situation requires it, or because it is easier to just pushing a button of this invention to select any peripheral -in case this option is available, and not by software-, instead trying to be finding the right option in the configuration section of the computer's software, which sometimes is very difficult and consume time. Therefore, this invention acts as portable redundant system of the connected host's microphone, speaker, memory and video-cam;
4. Use it as a USB hub: to connect other apparatuses in the invention's USB ports such as external memory, chargers, etc. The connection with the computer would be wired or wireless by using the wifi, Bluetooth or other similar feature connectivity.
5. Use it as a power bank: this invention can transfer power to its USB ports in different ways: i) when this invention is wired connected to a host through a USB-C cable or similar, or ii) when this invention is connected to an external A/C adapter (110/220 volts), or iii) when the rechargeable battery installed inside this invention acts as a power bank.
6. The use of this invention in a version of two monitors of approximately the same size will allow users to save space in the workplace, since they only require the area of a single monitor, but they are able to use two equal monitors vertically or horizontally. In this way, their desks will have more space to place other things or use smaller workspaces.
7. The use of a camera placed on two extended displays connected vertically to a host of computer, and at a height between 15″ to 25″ above the base allows users to have standing conferences, or make videos, or take photos without having to both ducking their heads to see their laptops or desktops and having access to the information provided by the two extended screens. For example, business executives, influencers, and other users who require or like multitasking and want to hold lectures standing up or show other angles of a rotating camera that is not available with regular computers.

### DESCRIPTION OF PRODUCTION

The multiple pieces of the outer shell of this invention are made of acrylonitrile butadiene styrene (ABS) plastic that has been injection molded. Sections of the outer shell may also have an additional material such as thermoplastic polyurethane (TPU) or silicone. The power, data and video transfer options would be done by using USB type C, USB2.0, HDMI among other available wired and wireless technologies. All buttons, switches, electrical micro-switches (made of plastic and metal) are also commodity components that have been manufactured and/or sourced from other suppliers. Integrated circuits, chipsets and printed circuit boards (PCB) are also standard items, although different proposed functions of the hub may have proprietary chipsets designed, printed and programmed to fit the requirements of each peripheral function that is to be added to the hub.

The printed circuit board (PCB) on which the electrical and mechanical components are mounted is custom-made for the functional design of the hub peripherals. It is a flat, resin-coated sheet. Electrical resistors, capacitors, oscillators, integrated circuits (ICs), and other components are made of various types of metal, plastic, and silicon, also sourced from manufacturers that produce in mass.

The general shape falls within the range of a top-end industrial design product that is available in the current market but may be produced slightly larger to accommodate for the added internal components that are built into the hub. The overall layout is similar as well, its orientation is symmetrical along a line that runs from the front to the back of the body of the hub along the top face. The hub has been detailed designed to obtain the smallest and carry-on size to allow for the addition of the proposed peripherals. On this hub, there are holes molded in the shell to allow for sounds to leave the device via internally mounted drivers. On the front there are activation buttons to accommodate the functions of the added devices that become mounted into the hub.

The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

What is claimed is:

1. A portable hub system comprising:
a primary display device;
a secondary display device, pivotally and rotatably connected at an edge of said primary display device;
a support base pivotally and rotatably connected to a second edge of said primary display device;
said support base having a pair of arms and a bottom area which form a U-shape to define an opening which receives said secondary display device in a closed position; said support base acting as a stand in an open position;
a built-in rotatable camera attached to said primary display device which unfolds upwards by means of a frictional hinge.

2. The portable hub system of claim 1 wherein said secondary display device is smaller in size relative to said primary display device.

3. A portable monitor system comprising:
a first display device;
a second display device pivotally and rotatably connected at a first edge of said first display device; said first and said second display devices are of the same size and deploy vertically;
a support base pivotally and rotatably connected to a second edge of said first display device; said support base having a pair of arms connected by a cross piece and attached to said first display device, said pair of arms and said cross piece defining an opening and said support base is received on a back side of said first display device when folded into a closed position and said support base acts as a stand for said portable monitor system when placed in an open position;
a built-in rotatable camera attached to said first display device which unfolds upwards by means of a frictional hinge.

4. The portable monitor system of claim 3 which requires only a single wired connection to transfer power and data to and from a host.

5. The portable monitor system of claim 3, wherein said second display device is rotated 90 degrees relative to said first display device.

6. The portable monitor system according to claim 3 wherein said built in rotatable camera has two rotation axes and is raised to a height of more than 15″ above the support base.
